(19) United States
(12) Patent Application Publication
(10) Pub. No.: US 2026/0091493 A1
(43) Pub. Date: Apr. 2, 2026

(54) MACHINES LEARNING ASSEMBLY TASKS USING PRE-TRAINED SKILL LIBRARIES

(71) Applicant: NVIDIA Corporation, Santa Clara, CA (US)

(72) Inventors: Yijie Guo, Seattle, WA (US); Bingjie Tang, Los Angeles, CA (US); Iretiayo Akinola, Gig Harbor, WA (US); Dieter Fox, Seattle, WA (US); Abhishek Gupta, Seattle, WA (US); Yashraj Narang, Seattle, WA (US)

(21) Appl. No.: 19/271,620

(22) Filed: Jul. 16, 2025

Related U.S. Application Data
(60) Provisional application No. 63/701,440, filed on Sep. 30, 2024.

(51) Int. Cl. B25J 9/16

(52) U.S. Cl. CPC B25J 9/1661; B25J 9/163

(57) ABSTRACT

To determine the actions of a machine assembly system (e.g., robotic assembly system), a relevant skill policy can be selected from a library of skill policies. The target task can be used to determine target task information, specifically, the geometry of one or more objects (e.g., parts) of the assembly task, one or more dynamic parameters of the objects, and expert actions that are specified. These parameters can be used as input into the skill library to predict the most relevant skill policy. The target task and the source task (e.g., a potential skill policy) can be compared on the metrics of geometry, dynamics, and expert actions. The best match skill policy can be returned as the relevant skill policy. This policy can then be modified, such as fine-tuning, to improve the real-world assembly outcomes.

### CROSS-REFERENCE

This application claims the benefit of U.S. Provisional Application Ser. No. 63/701,440, filed by Yijie Guo, et al., on Sep. 30, 2024, entitled “SKILL RETRIEVAL AND ADAPTION FOR ROBOTICS ASSEMBLY TASKS,” commonly assigned with this application and incorporated herein by reference in its entirety.

### TECHNICAL FIELD

This application is directed, in general, to robotics, and more specifically, to robotic assembly tasks.

### BACKGROUND

Humans excel at efficiently solving target tasks with minimal demonstrations or trial-and-error interactions. In robotic learning, a key challenge is enabling robots to learn control policies from sensor-based observations in a data-efficient manner. Achieving data-efficient learning is important for deploying robots in diverse real-world environments, such as home and industry. A compelling approach to efficient policy learning for novel tasks is the development of a foundation model or generalist policy that spans multiple tasks. Significant advancements have been made in robotic manipulation tasks, particularly in visual pre-training, multi-task policy learning, and policy generalization. Despite this progress, efficiently solving target tasks in contact-rich environments, such as robotic assembly, remains underexplored and a difficult challenge.

### SUMMARY

In one aspect, a tool for skill retrieval and skill adaption (SRSA) is disclosed. In one embodiment, the tool for SRSA includes (1) an interface configured to communicate data, wherein the data includes target task information associated with a target task, and (2) one or more processors to perform one or more operations that include (2A) retrieving, using the target task information, a relevant skill policy from a skill library to perform the target task, wherein the retrieving is based on a predicted success of the relevant skill policy and the relevant skill policy includes a source geometry of at least one source object and at least one task trajectory of the at least one source object, where the at least one source object is matched to a target object of the target task, and (2B) modifying the relevant skill policy for the target task using the target task information.

In a second aspect, a robotic assembly system is disclosed. In one embodiment, the robotic assembly system includes (1) a skill library configured to store skill policies, wherein each of the skill policies include source task information that includes a source task, a source geometry of at least one source object of the source task, at least one dynamic of the at least one source object, and at least one expert action of the at least one source object, and (2) one or more processors configured to receive a target task and target task information of the target task, retrieve a relevant skill policy from the skill policies to perform the target task utilizing a predicted success of the relevant skill policy to perform the target task with the target task information, and modify the relevant skill policy for the target task using the target task information, wherein the target task information includes a target geometry of at least one target object of the target task and at least one dynamic of the at least one target object.

In a third aspect, a method of operating a robot for a new assembly task is disclosed. In one embodiment, the method includes (1) receiving a target task, wherein the target task is an assembly task of at least two objects, (2) determining target task information associated with the target task, (3) retrieving, using the target task information, a relevant skill policy from a skill library to perform the target task, wherein the retrieving is based on a predicted success of the relevant skill policy, and (4) modifying the relevant skill policy for the target task.

In a fourth aspect, a non-transitory computer program product having a series of operating instructions stored on a non-transitory computer-readable medium that directs a robotic assembly system when executed thereby to perform operations. In one embodiment, the operations include (1) receiving a target task, wherein the target task is an assembly task of at least two objects, (2) determining target task information associated with the target task, (3) retrieving, using the target task information, a relevant skill policy from a skill library to perform the target task, wherein the retrieving is based on a predicted success of the relevant skill policy, and (4) modifying the relevant skill policy for the target task.

### BRIEF DESCRIPTION

Reference is now made to the following descriptions taken in conjunction with the accompanying drawings, in which:

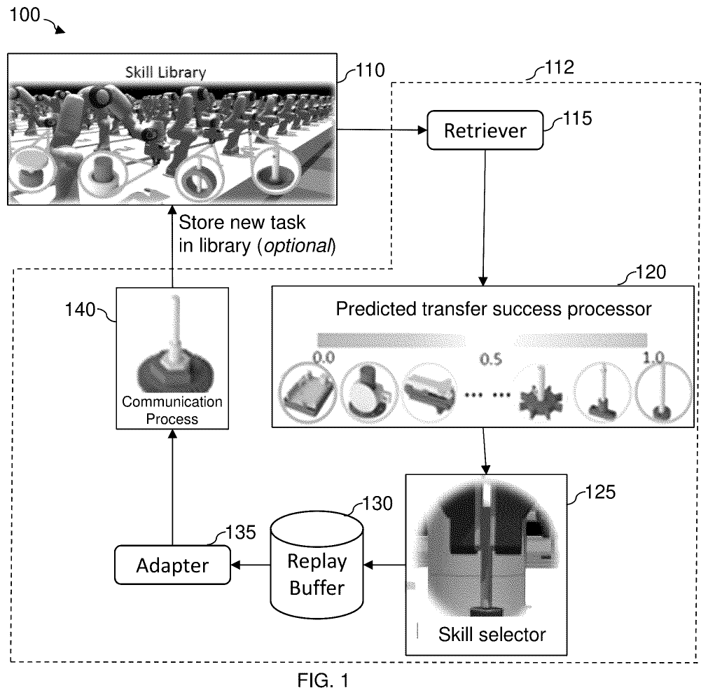

FIG. 1 is an illustration of a block diagram of an example robotic assembly system having an SRSA tool constructed according to the principles of the disclosure;

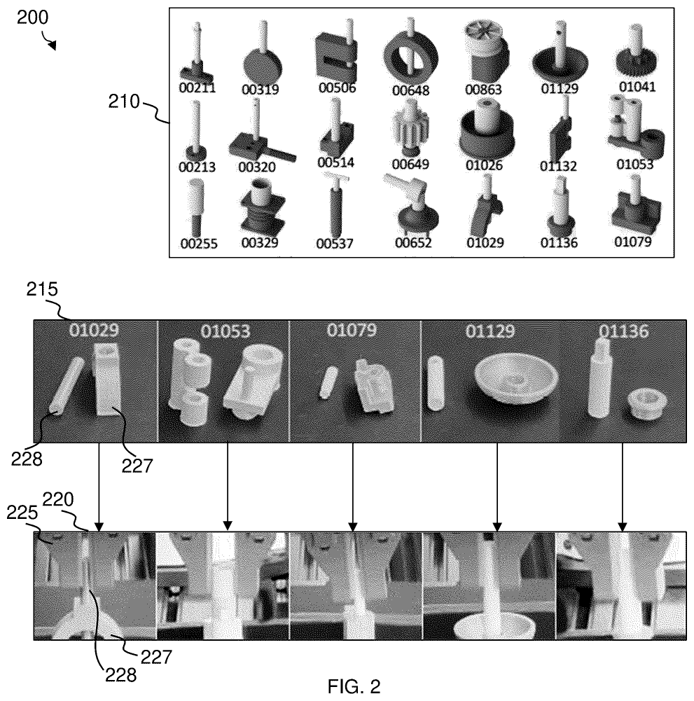

FIG. 2 is an illustration of a diagram of example parts used for assembly training;

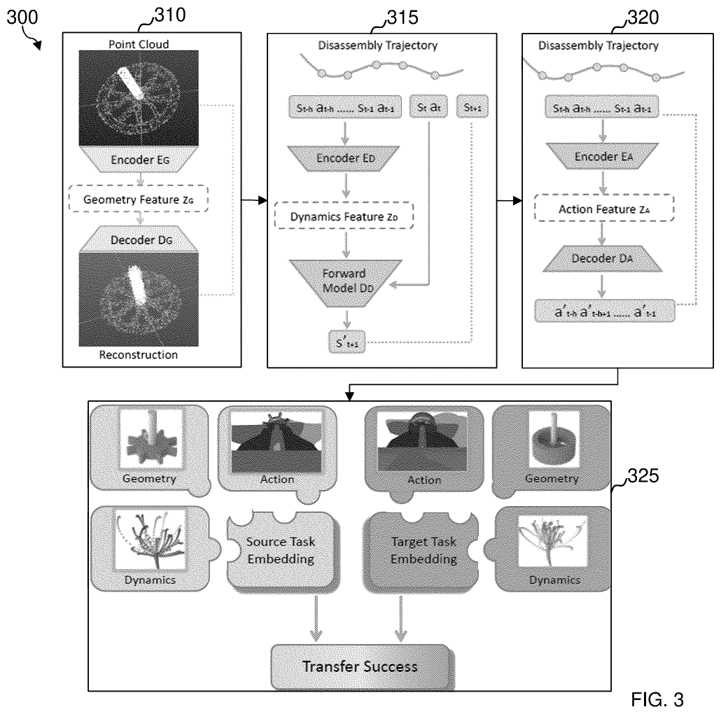

FIG. 3 is an illustration of a flow diagram of an example skill retrieval approach;

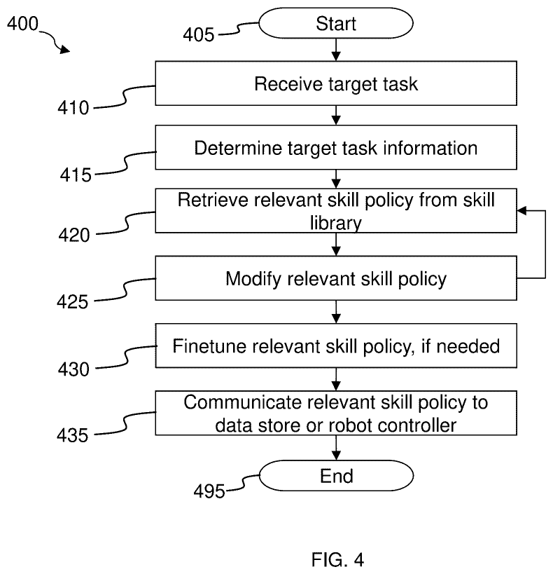

FIG. 4 is an illustration of a flow diagram of an example method to determine a relevant skill policy;

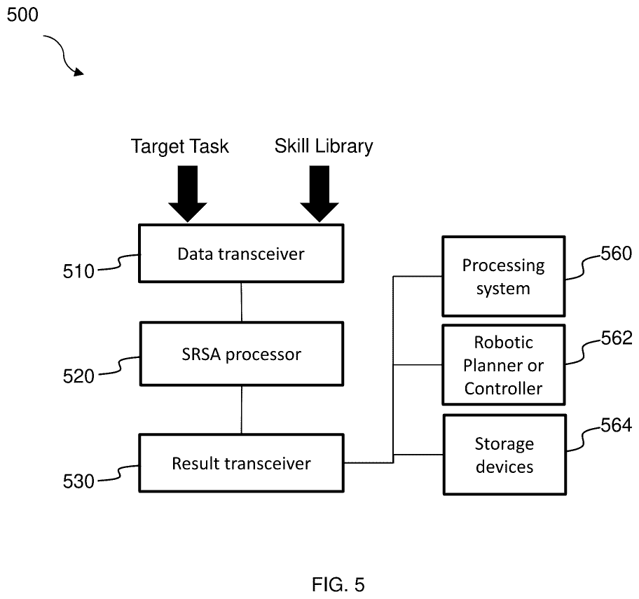

FIG. 5 is an illustration of a block diagram of an example SRSA system; and

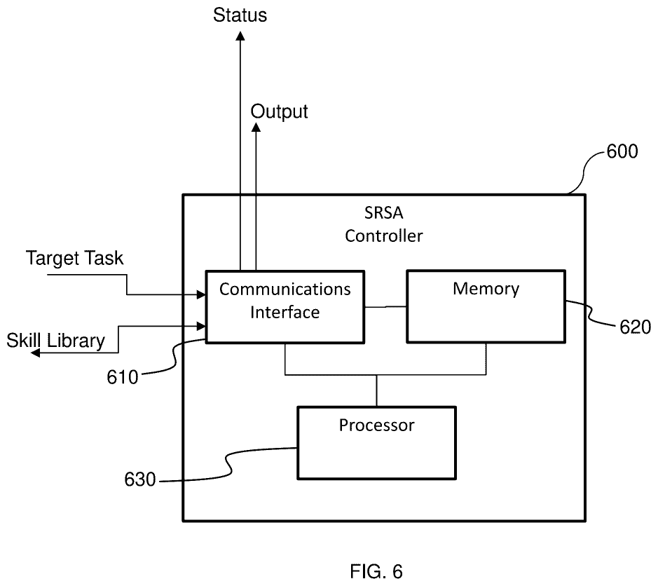

FIG. 6 is an illustration of a block diagram of an example of an SRSA controller according to the principles of the disclosure.

### DETAILED DESCRIPTION

Robotic assembly plays a critical role in industries, for example, automotive, aerospace, and electronics, while learning assembly policies for robotic assembly systems can be difficult. These tasks can use contact-rich interactions with high levels of precision and accuracy, compounded by the physical complexity of the environment, part variability, and strict reliability standards. Much existing research focuses on training specialist policies for individual assembly tasks. Building on the strengths of these specialist approaches, the disclosed processes present a skill library, e.g., a collection of diverse specialist policies and associated information (such as object geometry and task trajectories) for various assembly tasks. These policies, regardless of the training strategies or learning approaches used to develop them, can be harnessed to improve the efficiency in solving previously unseen assembly challenges.

To utilize prior task experiences, previous work on general pick-and-place tasks has explored methods such as imitating state-action pairs from expert demonstrations and encoding sub-task skills as macro-action choices. Unlike these approaches, which focus on reusing data or subtask skills, this disclosure centers on adapting policies from previous tasks to solve novel tasks. These policies can encapsulate essential task-solving knowledge, making them a valuable starting point for further refinement. Despite having access to a library of policies, identifying the most relevant ones for fine-tuning on target tasks can be difficult, and the success of fine-tuning can hinge on making the right selection.

The disclosed processes demonstrate a pipeline to retrieve and adapt specialist policies to solve new assembly tasks. To learn a retrieval model, features from geometry, dynamics, and expert actions can be jointly learned to represent tasks and predict transfer success to implicitly capture other transfer-related factors from tasks. Dynamics describe the state transition of the environment, i.e., the probability distribution of the next state given the current state and action. By combining skill retrieval with policy fine-tuning and self-imitation learning, the disclosed processes can improve the efficiency in learning simulation-based policies. Fine-tuning refers to the process of taking a pre-trained model and continuing to train it on a new task or dataset, usually with a smaller learning rate and often using fewer labeled examples than were needed to train the model from scratch. Self-imitation learning is a reinforcement learning algorithm. It stores the high-rewarding transitions encountered during policy learning. It encourages the policy to imitate the high-rewarding transitions. These policies are transferable to real-world robots for assembly tasks. The disclosed processes can be utilized to grow a skill library, leading to faster skill adaptation over time. One issue is that the success rate of real-world deployment may not consistently exceed 95% across diverse tasks. To overcome this issue, policy fine-tuning can be used as reinforcement learning directly in real-world settings that can help bridge the sim-to-real gap and improve success rates.

The disclosed processes, labeled as skill retrieval and skill adaption (SRSA) in this disclosure, can retrieve policies for similar tasks and adapt them to target tasks. SRSA provides several features. (1) A skill retrieval process can learn embeddings for geometry, dynamics, and expert action choices. In some aspects, the skill retrieval process can operate simultaneously with other skill retrieval processes. In some aspects, the skill retrieval process can operate explicitly. In some aspects, an objective can be used to predict transfer success across various source policies and target tasks, which can implicitly capture critical factors for policy transfer. This approach can enable improved effectiveness in retrieving relevant skills, resulting in higher zero-shot transfer success when applied to target tasks. In some aspects, retrieving the relevant skill policy includes computing a transfer success prediction between each source policy in the skill library and the target task, and selecting the source policy with the highest predicted transfer success score as the relevant skill policy for the target task. In some aspects, the relevant skill policy can be further fine-tuned for the target task.

(2) A second feature is a skill adaptation process: A self-imitation learning process can be used to improve performance and stability during fine-tuning on novel tasks. In a dense-reward setting, in one example round of testing against conventional solutions, SRSA can achieve 22.0% higher success rates with 2.4× faster training and 3.7× greater stability. These are example improvement parameters, while each implementation can vary as to the improvement parameters experienced. In other example testing results, policies that are fine-tuned in simulation can be directly transferred to real-world robots, achieving a 90.0% average success rate without the need for additional retraining. This zero-shot transfer capability highlights the potential for deploying high-performance solutions in real-world assembly tasks.

(3) A third feature is continual learning with skill library expansion. Rather than training numerous specialized policies in parallel, SRSA can gradually expand a small set of initial skills to cover a broader range of tasks. For example, a small set of initial skills can be 10, in other aspects, a lower or higher number can be used. This strategy can improve sample efficiency by over 50.0% compared to conventional solutions. SRSA can become increasingly efficient as the skill library grows. This provides a process to accumulate a large-scale collection of specialist policies.

SRSA considers the problem of solving a new target task and leverages pre-existing skills from a skill library. This library can contain a set of policies, e.g., one or more policies, wherein each policy can be designed to solve a specific previously encountered task. SRSA can draw on knowledge from previously learned policies to adapt quickly to a new task.

Similar to multi-task reinforcement learning formulation, SRSA can use a task space [symbol] where each task T∈ [symbol] is defined as a Markov Decision Process (MDP) ( [symbol] , [symbol] , [symbol] , r, γ, ρ). In this formulation, [symbol] represents the state space, [symbol] represents the action space, [symbol] (sₜ₊₁|sₜ, aₜ) represents the transition dynamics, r(sₜ, aₜ) represents the reward function, ρ represents the initial state distribution, and γ∈[0, 1) represents the discount factor.

This disclosure demonstrates the processes using two-part assembly tasks. Each environment includes a Franka robot, a plug, and a socket. In the initial state, the robot and socket configurations are randomized, while the plug is randomly positioned within the robot's gripper. The task goal is to insert the plug into the corresponding socket. The state space [symbol] consists of the robot arm's joint angles and velocities, the end-effector pose, and its linear and angular velocities, the current plug pose, and the end-effector goal pose. The action space [symbol] consists of incremental pose targets for a task-space impedance controller. Disassembly trajectories can be generated for each task as reverse demonstrations for imitation learning. The reward function can be composed of terms that penalize the distance to the goal, account for simulation error, reward task difficulty in the curriculum, and imitate the disassembly path. The assembly tasks vary in part geometries and poses, sharing the same state space [symbol] and action space [symbol] , while differing in their transition dynamics [symbol] and initial state distribution ρ.

Task space [symbol] has access to a prior task set [symbol] ={T₁, T₂, T₃, . . . , Tₙ}⊆ [symbol] . The policy space can be denoted as Π: [symbol] → [symbol] and the skill library contains policies Πₚᵣᵢₒᵣ={π₁, π₂, π₃, . . . πₙ}⊆Π that solve each of the prior tasks. To solve a new target task T∈ [symbol] , the goal of reinforcement learning (RL) is to find a policy π(aₜ|sₜ) that produces an action for each state to maximize the expected return, i.e., the total discounted accumulated reward. SRSA can first retrieve a skill (i.e., policy) for the most relevant prior task, and then adapt to the target task by fine-tuning the retrieved skill.

To effectively retrieve skills from Πₚᵣᵢₒᵣ that are useful for target task T, SRSA can measure the potential of applying a policy π to task T. SRSA aims to obtain a function F: Π× [symbol] → [symbol] , which takes as input a source policy and a target task and produces a scalar score measuring how well the source policy can be adapted to the target task.

For an example of how SRSA can be implemented, consider a source task Tⱼ and target task Tᵢ sharing the state space, action space, and reward function. To measure the transferability of a policy, the same policy can be applied to each task and the difference in their expected values can be examined. The value difference can depend on the difference in the transition function pᵢ, pⱼ and initial state distribution ρᵢ, ρⱼ (see Proposition 1).
Proposition 1: Example function to determine how well a source policy can be adapted to a target task

Let Tᵢ={ [symbol] , [symbol] , [symbol] ᵢ, r, γ, ρᵢ} and Tⱼ={ [symbol] , [symbol] , [symbol] ⱼ, r, γ, ρⱼ} be two MDPs in the task space [symbol] . Applying a policy π on Tᵢ and Tⱼ, there is a function f to describe the value difference: V^{π}(ρᵢ, Tᵢ)−V^{π}(ρⱼ, Tⱼ)=ƒ(pᵢ−pⱼ, ρᵢ−ρⱼ).

Assume the reward function r is a sparse, binary term indicating task success at the end of an episode. The success rate of applying a policy π to a task T can be represented as

$${V}^{π} ( ρ ) = {𝔼}_{{s}_{0 \sim ρ}} {𝔼}_{𝒥 \sim {p}^{π} ( 𝒥 \vert s = {s}_{0} )} [ {\sum }_{t = 0}^{∞} {γ}^{t} {r}_{t} ] .$$

The success rate V^{π}(ρⱼ, Tⱼ) can be high, because the source policy π is a high ranked expert policy for the source task Tⱼ. When the success rate of applying the source policy to target task Ti is high, i.e., V^{π}(ρᵢ, Tᵢ) is close to V^{π}(ρⱼ, Tⱼ), the transition functions pᵢ and pⱼ are similar, as are the initial state distributions ρᵢ and ρⱼ, (see Proposition 1). If a source policy can achieve high zero-shot transfer success on a target task, then the target task has a similar initial state distribution and transition function as the source task. For example, a high zero-shot transfer success can be targeted at 90.0%. In other aspects, a different target can be used. The target can be specified through input parameters. Therefore, fine-tuning the source policy on the target task can be an efficient use of resources.

To identify a source policy that achieves high zero-shot transfer success on the target task, a function F can be used to predict the zero-shot transfer success for any pair of source policy and target task parameters. The prediction F(π_{src}, T_{trg}) can serve as a guide, indicating whether π_{src} is a good candidate to initiate fine-tuning for the target task T_{trg}.

In order to train the prediction function F, a dataset of tuples (π_{src}, T_{trg}, r_{src,trg}) can be used, where r_{src,trg} denotes the zero-shot transfer success of the source policy π_{src} when applied to the target task Ttrg. In some aspects, due to the limited number of (π_{src}, T_{trg}) pairs-specifically n×n pairs for a total of n tasks in [symbol] , a sufficient featurization of the source policy and target task can be needed for an efficient learning of F. The source policy π_{src} is an expert policy for the corresponding source task T_{src} and there is a one-to-one mapping between policies and tasks in the skill library. Thus, the features of the source task can be utilized to represent the source policy. For assembly tasks differing in parts' geometries and poses, the features related to geometry, dynamics, and expert action can be used to represent tasks, allowing the learning of the transfer success prediction in F.

In some aspects, a framework can be used to jointly capture features of geometry, dynamics, and expert actions to represent a robotics assembly task. For each task, the mesh of parts and disassembly trajectories is available. The disassembly trajectories can be generated by employing a low-level controller that lifts the plug from the socket and moves it to a randomized pose. These disassembly trajectories can be used as reverse expert demonstrations, encapsulating essential features to solve a specific task. With the input of parts' point cloud or transition sequence from disassembly trajectories, encoders E_{G}, E_{D}, and E_{A} can be learned to capture features z_{G} (representing geometry), z_{D} (representing forward dynamics), and z_{A} (representing expert action choices). Decoders D_{G}, D_{D}, and D_{A} can be used for conditioning on these features to predict a point cloud for geometry, a next state for dynamics, or an action sequence for expert action choices.

In some aspects, task features can be consolidated to develop the transfer success prediction function F. During training, two tasks from the prior task set [symbol] can be selected as a source-target task pair. For each pair (π_{src}, T_{trg}), the source policy π_{src} can be evaluated on the target task T_{trg} to obtain the zero-shot transfer success rate r_{src,trg}. This process can enable the collection of the training dataset of tuples (π_{src}, T_{trg}, r_{src-trg}) from the prior skill library.

The point cloud and transition segments can be input into encoders. The features of geometry, dynamics, or expert action can be concatenated together to get task features z_{src} and z_{trg}. Then the concatenated task features go through an MLP to predict the transfer success r_{src,trg}. Function F can be trained using, for example, Objective Function 1.

### Objective Function 1: Example Training of the Function

$$ℒ = - {‖ F ( {π}_{sec} , {T}_{trg} ) - {r}_{src , trg} ‖}^{2} = - {‖ MLP ( {z}_{src} , {z}_{trg} ) - {r}_{src , trg} ‖}^{2} = - {‖ MLP ( {E}_{g} ( {P}_{src} ) , {E}_{D} ( {𝒥}_{src} ) , {E}_{A} ( {𝒥}_{src} ) , {E}_{G} ( {P}_{trg} ) , {E}_{D} ( {𝒥}_{trg} ) , {E}_{A} ( {𝒥}_{trg} ) ) - {r}_{src , trg} ‖}^{2}$$

Function F can be used to predict the transfer success of applying a prior policy to a target task T_{trg} as F(π_{src}, T_{trg}). For inputs to the function F, sample of the point clouds P₁, P₂, . . . , Pₘ from the parts' meshes and transition segments τ₁, τ₂, . . . , τₘ from disassembly trajectories can be used. The prediction parameter for these samples can be computed using various algorithms, for example, an average algorithm as shown in Equation 1. In this manner, the predicted transfer success F(π_{src}, T_{trg}) can be inferred for source policies π_{src} in the prior skill library Πₚᵣᵢₒᵣ={π₁, π₂, . . . , πₙ}. The retrieved policy can be the source policy with the highest predicted transfer success, defined as arg max_{π}_{_{src}}F(π_{src}, T_{trg}).

### Equation 1: Example Computation for a Prediction Parameter

$$F ( {π}_{src} , {T}_{trg} ) = \frac{1}{m} {\sum }_{i = 1}^{m} MLP ( {E}_{G} ( {P}_{src , i} ) , {E}_{D} ( {𝒥}_{src , i} ) , {E}_{A} ( {𝒥}_{src , i} ) , {E}_{G} ( {P}_{trg , i} ) , {E}_{D} ( {𝒥}_{trg , i} ) , {E}_{A} ( {𝒥}_{trg , i} ) )$$

The retrieved skill can be used to initialize the policy network π_{θ}(aₜ|sₜ). Subsequently, a proximal policy optimization (PPO) can be used to fine-tune the policy on the target task. This initialization provides a start for policy learning, so that the initial trials with the retrieved skills can achieve a reasonable success rate. A replay buffer D={(sₜ, aₜ, Rₜ)} can be used to store the transitions encountered throughout training, where

$${R}_{t} = {\sum }_{t = 0}^{∞} {γ}^{k - t} {r}_{k}$$

is the discounted sum of rewards. The state-action pairs (sₜ, aₜ) can be prioritized based on their discounted accumulated rewards R, and imitate those pairs with high rewards. Objective function 2 is an example of policy learning.

### Objective Function 2: Example Policy Learning Function

$${ℒ}^{sil} = {𝔼}_{( s , a , R ) ∈ D} [ {ℒ}_{policy}^{sil} + {βℒ}_{values}^{sil} ] , {ℒ}_{policy}^{sil} = - log {π}_{θ} ( a \vert s ) {( R - {V}_{θ} ( s ) )}_{+} , {ℒ}_{policy}^{sil} = \frac{1}{2} {‖ {( R - {V}_{θ} ( s ) )}_{+} ‖}^{2}$$

where ( . . . )₊=max( . . . , 0), and
π_{θ} and V_{θ} are the policy and value functions parameterized by θ.

Pseudocode 1 demonstrates an example of implementation of objective function 2.

```
Pseudocode 1: Example policy fine-tuning with self-imitation learning
Initialize parameter θ for policy π_{θ} and value function V_{θ} with retrieved
skill
Initialize replay buffer D ← Ø
Initialize episode buffer E ← Ø
for each iteration do
  # Collect training samples
  for each step do
    Execute an action sₜ, aₜ, rₜ, sₜ₊₁ ~ π_{θ}(aₜ|sₜ)
    Store transition E ← E ∪ {(sₜ, aₜ, rₜ)}
  end for
  if sₜ₊₁ is terminal then
    # Update replay buffer
    $Compute returns {R}_{t} = {\sum }_{k}^{∞} {γ}^{k - t} {r}_{k} for t in E$
    D ← D ∪ {(sₜ, aₜ, Rₜ)} for t in E
    Clear episode buffer E ← Ø
  end if
  # Update parameter θ using PPO objective
  θ ← θ − η∇_{θ} [symbol]
  # Perform self-imitation learning
  for m = 1 to M do
    Sample a mini-batch {(s, a, R)} from D
    θ ← θ − η∇_{θ} [symbol]
  end for
end for
```

As training progresses, the agent can collect higher rewards on the target task, leading to an expanding replay buffer filled with improved experiences. This self-imitation mechanism can accelerate the agent's convergence to encountered high-rewarding behavior, even though it may introduce some bias into the policy. The behavior derived from the retrieved skill can be advantageous for the target task. Self-imitation learning can enhance and stabilize policy fine-tuning, where the beneficial effects are increased in sparse-reward scenarios.

The primary objective of continual learning can be to overcome the forgetting of previously learned tasks and to leverage the earlier knowledge for obtaining better performance or faster convergence, or training speed on the newly learned tasks. SRSA can be integrated with a continual learning system while expanding the skill library. Continual learning can start with an initial skill library Πₚᵣᵢₒᵣ corresponding to prior tasks Tₚᵣᵢₒᵣ. When faced with a new batch of tasks T^{j}={T₁, T₂, . . . , Tₖ}, SRSA can be used to retrieve and fine-tune policies for each target task Tᵢ. The learned policies can then be incorporated into [symbol] = [symbol] ∪{Tᵢ}; Πₚᵣᵢₒᵣ=Πₚᵣᵢₒᵣ∪{πᵢ}. This approach allows an improved efficiency in tackling target tasks by leveraging the skill library and simultaneously prevents the forgetting of previously learned tasks by maintaining the skill library. Pseudocode 2 is an example implementation of continual learning.

Pseudocode 2: Example continual learning with skill library expansion

```
0: Prior tasks τₚᵣᵢₒᵣ = {T₁, T₂, ••• , Tₙ}; Skill Library Πₚᵣᵢₒᵣ = {π₁, π₂, ••• , πₙ}
1: while given newly coming batch of tasks τ^{j} = {T₁, T₂, ••• , Tₖ} do
2: for each task Tᵢ do
  3: Retrieve a policy π_{src} from the skill library Πₚᵣᵢₒᵣ
  4: Fine-tune π_{src} to get a policy πᵢ solving the task Tᵢ
  5: Expand the skill library, τₚᵣᵢₒᵣ = τₚᵣᵢₒᵣ∪{Tᵢ} ; Πₚᵣᵢₒᵣ = Πₚᵣᵢₒᵣ∪{πᵢ}
6: end for
7: end while
```

The objective can be to minimize the difference between input point cloud P and reconstructed point cloud D_{G}(E_{G}(P)). The autoencoder can be trained with the point clouds of parts on the tasks. In a large set of meshes M for various assembly parts, each mesh mᵢ∈M can consist of (Vᵢ,Eᵢ), where V are the vertices and E are the (undirected) edges. At each training iteration, a batch of meshes B⊂M; for each mᵢ∈B can be sampled. A point cloud Pᵢ online can be sampled with each point lying on the surface of mᵢ. The point cloud Pᵢ can be passed to an encoder to produce a latent vector zᵢ. Vector z_{G,i} can be passed to a fully-convolutional decoder to produce a reconstructed point cloud P′ᵢ. The network can be trained to minimize reconstruction loss, defined here as the Chamfer distance between Pᵢ and P′ₜ, for example, shown in Objective Function 3.

### Objective Function 3: Example Point Cloud Evaluation to Minimize Reconstruction Loss

$${ℒ}_{CD} = \frac{1}{‖ {P}_{i} ‖} {\sum }_{p ∈ {P}_{i}} {min}_{p ∈ {Q}_{i}} {‖ p - q ‖}_{2}^{2} + \frac{1}{‖ {Q}_{i} ‖} {\sum }_{q ∈ {Q}_{i}} {min}_{p ∈ {P}_{i}} {‖ p - q ‖}_{2}^{2} +$$

For this disclosure, an example set of 100 two-parts assembly tasks are used to demonstrate the processes. This is for demonstration purposes and other implementations, or training can use different number of parts, meshes, batch sizes, epochs, and learning rates. The 100 two-parts assembly tasks lead to a total of 200 meshes for the plug and socket parts |M|=200. This can lead, for example, to having each sampled point cloud contains 2,000 points and the dimension of learned embedding would then be |z_{G,i}|=32. The autoencoder can be trained for a total of 23,000 epochs with a batch size 64 and a learning rate of 0.001. The learning rate is a hyperparameter that controls how much the model's weights are updated during training in response to the computed error or loss. To represent the feature of one task, the geometry features z_{G} can be gathered for the meshes of the plug, socket, and the assembled state. Thus, the geometry feature of one task can be the concatenation of these three, |z_{G}|=96.

For context-based meta-RL, a context encoder E_{D} can be utilized to produce a latent vector from transition segments τₜ₋₁={sₜ₋ₕ, aₜ₋ₕ, sₜ₋ₕ₊₁, aₜ₋ₕ₊₁, . . . , sₜ₋₁, aₜ₋₁}. The transition segments can be sampled from disassembly trajectories. A forward dynamics model D_{D} can be trained across the tasks, conditioning on the latent vector E_{D}(τₜ₋₁). For transition samples from tasks, the forward dynamics model can be trained to predict the next state s′ₜ₊₁=D_{D} (E_{D}(τₜ₋₁), sₜ, aₜ) to be close to the ground-truth next state sₜ₊₁.

There is a total of 100 disassembly trajectories on each task and each disassembly trajectory spans over 128 timesteps. The transition segment τₜ₋₁={sₜ₋ₕ, aₜ₋ₕ, sₜ₋ₕ₊₁, . . . , sₜ₋₁, aₜ₋₁} can be sampled for 10 timesteps, i.e., h=10. The context encoder can be modeled as multi-layer perceptrons (MLPs) with 3 hidden layers of size (256, 128, 64) that produce a 32-dimensional vector z_{D,t}. Then, the forward dynamics model D_{D} can receive the context vector as an additional input, i.e., the input can be given as a concatenation of state sₜ, action aₜ, and context vector z_{D,t}. The forward dynamics model can be composed of four fully-connected layers of size (200, 200, 200, 200) with an activation function, and it can output the prediction of the next state s′ₜ₊₁. The objective is to minimize the L2-distance between the ground-truth next state sₜ₊₁ and s′ₜ₊₁. For the set of disassembly trajectories on 100 tasks, the encoder and decoder can be trained for 200 epochs, with a batch size 128 and a learning rate 0.001.

The disassembly trajectories can be used as reverse expert demonstrations for assembly tasks. Expert action information can be captured in an embedding space. A transition segment τₜ₋₁ can be sampled from the disassembly trajectories, it can be mapped to an action embedding E_{A}(τₜ₋₁), and then the process can reconstruct the action sequence {aₜ₋ₕ, aₜ₋ₕ₊₁, . . . , aₜ₋₁} with decoder D_{A}. The encoder and decoder can be trained with transition segments from the tasks. Such an embedding can extract the strategy of solving the task by reconstructing the expert action in disassembly trajectories.

The transition segment τₜ₋₁={sₜ₋ₕ, aₜ₋ₕ, sₜ₋ₕ₊₁, aₜ₋ₕ₊₁, . . . , sₜ₋₁, aₜ₋₁} can be sampled for 10 timesteps, i.e., h=10. The action encoder E_{A} can be modeled as MLPs with 3 hidden layers of size (256, 128, 64) that produce a 32-dimensional vector z_{A,t}. The action decoder D_{A} can be an MLP with 4 hidden layers of size (200, 200, 200, 200) to predict the sequence of actions {a′ₜ₋ₕ, a′ₜ₋ₕ₊₁, . . . , a′ₜ₋₁}. The L2-distance between input action sequence {aₜ₋ₕ, aₜ₋ₕ₊₁, . . . , aₜ₋₁} and the reconstructed action sequence {a′ₜ₋ₕ, a′ₜ₋ₕ₊₁, . . . , a′ₜ₋₁} can be minimized. The encoder and decoder can be trained, for example, for 200 epochs, with a batch size of 128 and a learning rate of 0.001.

The function F(π_{src}, T_{trg}) can be used to predict the transfer success. For any pair of source policy and target tasks in the skill library, the source policy can be run for the target task for a number of episodes (for example, 1000 episodes). The average of the success rates can be calculated to determine the ground-truth label for F. For any task T in a prior task set, the point cloud Pᵢ of plug and socket and assembly states can be sampled separately in this task to extract the geometry feature z_{G,i} of a dimension, such as dimension 96. Then the transition segment τᵢ can be sampled to determine the dynamic features z_{D} of a second dimension, such as dimension 32, and determine the action feature of dimension z_{A}. These features can be concatenated to determine a task feature zᵢ with a third dimension, such as dimension 160, for this sample of point clouds and transition segment. Task features z_{src,i} and z_{trg,i} for source and target tasks can be used as inputs to an MLP with one hidden layer of a size, such as size 128, to predict the transfer success. The feature encoders E_{G}, E_{D}, and E_{A} can be fine-tuned, and the MLP can be jointly optimized to learn the transfer success prediction. The training can take a number of epochs, for example, 50 epochs, for the source-target pairs in a prior task set.

Path signatures can represent trajectories as a collection of path integrals and can quantify distances between trajectories. The closest path signature can be found for each skill retrieval. For each disassembly trajectory τₖ on the target task T, the path signature zₖ can be calculated. Then a search of disassembly trajectories over the source tasks can be conducted to identify a source disassembly trajectory τⱼ with the path signature zⱼ closest to zₖ. The source disassembly trajectory τⱼ belongs to a source task in [symbol] , and thus the target trajectory τₖ can be matched to this source task, denoted as Tₖ. The times that one source task T_{src}∈ [symbol] is assigned as the source task for a target disassembly trajectory,

$$C ( {T}_{src} ) = {\sum }_{k = 1}^{n} [ {T}_{k} = {T}_{src} ] ,$$

can be counted. Then the source policy for one source task with the highest count, i.e., arg max_{T}_{_{arc}}C(T_{src}), can be retrieved.

State-action pairs can be employed on disassembly trajectories across the tasks to learn a state-action embedding with a VAE for skill retrieval. For a state-action pair (sₖ, aₖ) on the target task, the embedding z_{sa,k} can be inferred. One state-action pair (sⱼ, aⱼ) can be determined from the disassembly trajectories in source tasks with the embedding z_{sa,j} closest to z_{sa,k}. The target state-action pair (sₖ, aₖ) can be matched to one source task, which (sⱼ, aⱼ) belongs to. This source task can be denoted as Tₖ. Similar to the method above, the times that one source task T_{src}∈ [symbol] is assigned as the source task for a target state-action pair,

$$C ( {T}_{src} ) = {\sum }_{k = 1}^{n} [ {T}_{k} = {T}_{src} ]$$

can De counted. Then the source policy for one source task with the highest count, i.e., arg max_{T}_{_{arc}}C(T_{src}) can be retrieved.

The latent vector for the transition sequence t can be determined from disassembly trajectories. In order to retrieve one source task according to the distances between task embeddings, embeddings can be averaged for transition sequences from the same task to obtain the task embedding. The policy for the source task that has the closest task embedding can then be retrieved. An autoencoder for the point clouds of the assembly assets can be determined to minimize the reconstruction loss. The policy for the source task with the closest point-cloud embedding can be retrieved.

Turning now to the figures, FIG. 1 is an illustration of a block diagram of an example robotic assembly system 100 (e.g., a machine assembly system) utilizing an SRSA tool 112 constructed according to the principles of the disclosure. SRSA tool 112 is a functional representation of the described processes. The functions can be implemented as software processes, hardware processes, or various combinations thereof. Intelligent agents can use a large library of acquired skills when learning new tasks. They can select relevant skills from the skill library to improve learning efficiency. This disclosure shows how to predict the transfer success of applying prior skills (i.e., policies) to target tasks and retrieve the skill with the highest transfer success prediction. When fine-tuning the retrieved skill on target tasks, imitation learning of transitions from the agent's replay buffer collected during fine-tuning can be incorporated to accelerate the adaptation.

Robotic assembly system 100 has a skill library 110 and one or more processors configured to perform operations as described by SRSA tool 112. A retriever 115 can retrieve skills for source objects that can be applicable to the target task. A predicted transfer success processor 120 can analyze the skill policies from skill library 110 to generate a prediction of how well the skill policies will fit the target task, for example, using Proposition 1, Objective Function 1, or Equation 1. The prediction process can take into account one or more of the source object geometries from each of the skill policies as compared to the target object geometry, the source object dynamics as compared to the target object dynamics, or other factors.

A retrieved skill policy that has the highest predicted transfer success (or if a tie among two or more skill policies, the system can select one using an algorithm or select by random) can be selected by skill selector 125 for use with the target object. A replay buffer 130 can be used to store the retrieved skill policy. An adapter 135 can be applied to modify the skill policy to improve the fit (e.g., transfer) to the target object, such as minor orientation changes or other fine-tuning processes. In some aspects, adapter 135 can utilize Objective Function 2, or Pseudocode 1. In some aspects, adapter 135 can utilize Objective Function 3 to minimize the reconstruction loss during reply of the directed actions. The fine-tuned skill policy can then be used for new tasks with the target object, such as with communication process 140, where communication process 140 can communicate the fine-tuned skill policy to a robotic controller or a robotic planner, or store the fine-tuned skill policy in skill library 110 or a different skill library. In some aspects, robotic assembly system 100 can include a robotic assembler that can be directed by the fine-tuned skill policy, as communicated by communication process 140, to perform the operations comprising the new task. The fine-tuned skill policy can be saved back into skill library 110, along with the target object geometry and target object dynamics as a new skill policy for use with other target objects, for example, as shown in Pseudocode 2.

FIG. 2 is an illustration of a diagram of example parts 200 used for assembly training. Parts 200 are based on the AutoMate training parts. Tasks 210 demonstrate a sample of assembly tasks used within the AutoMate benchmark. Parts 215 demonstrate some real-world assembly tasks, such as an assembly of part 227 and part 228. Video frames 220 demonstrate visuals of how parts 215 can be assembled using keyframes in a video recording of the real-world deployment of the fine-tuned skill policy from communication process 140 of FIG. 1 The first frame of video frames 220 shows a robotic assembler 225 assembling part 227 and part 228. Tasks 210 and parts 215 can be used to train the system and add new fine-tuned skill policies to the skill library.

FIG. 3 is an illustration of a flow diagram of an example skill retrieval approach 300. Skill retrieval approach 300 can decompose the skill retrieval process, as represented by retriever 115 of FIG. 1, into task feature learning and transfer success prediction. Task feature learning can include extracting geometry features from point cloud reconstruction of the target object involved in the target task, extracting dynamics features by predicting a next state of the target object given a current state and an action of the target object, and extracting expert action features by predicting the action from an observed state transition using inverse dynamics prediction. Transfer success prediction can be performed using a neural network trained to predict the transferability between a source task of the source object and the target task, wherein the neural network receives as input a combination of source task features and target task features, and outputs a predicted transfer success score representing how well the relevant skill policy applies to the target task. The source task features include, for example, at least one source object with encoding of the geometry, an encoding of task dynamics, and an encoding of expert actions, and the target task features include of the target object with an encoding of the geometry, an encoding of task dynamics, and an encoding of expert actions.

A box 310 demonstrates an autoencoder capturing geometry features from a point cloud input. In some aspects, data for the point cloud can be retrieved from the skill library as part of the selected skill policy, e.g., part of the meta data for the source object. In some aspects, data for the point cloud can be collected from one or more sensors, such as sensors observing one or more of the target objects. The sensors can be one or more sensors of various types, such as from video sensors, acoustic sensors, laser sensors, other sensor types, or various combinations of sensor types. A box 315 demonstrates a forward dynamics model conditioning on dynamics features from transition segments. A box 320 demonstrates learning features to extract expert action choices about solving the task, given the input of transition segments. A box 325 demonstrates a prediction of the transfer success rate of applying a source policy to a target task, leveraging features from the source and target tasks.

FIG. 4 is an illustration of a flow diagram of an example method 400 to determine a relevant skill policy. Method 400 can be performed on a computing system, for example, SRSA system 500 of FIG. 5 or SRSA controller 600 of FIG. 6. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 400 can be encapsulated in software code or hardware, for example, an application, code library, code module, dynamic link library, module, function, RAM, ROM module, and other software and hardware implementations. The software can be stored in a file, database, or other computing system storage mechanism. Method 400 can be partially implemented in software and partially in hardware. Method 400 can perform the steps for the described processes, for example, updating the skill library or determining a relevant skill policy to perform an assembly operation using objects associated with the target task. In some aspects, portions of method 400 can be performed within a simulated (e.g., virtual) environment.

Method 400 starts at a step 405 and proceeds to a step 410. In step 410 input parameters are received. The input parameters can include a target task, including information about objects (e.g., parts) associated with the target task. The target task information can include at least one of the geometry of the object, the dynamics of the object, or an expert action associated with the object. The input parameters can include one or more threshold parameters, such as a zero-shot threshold to indicate the match percentage of the target task to a source task. The input parameters can include operational parameters to specify how the process operates, for example, indicating which skill library to use if there is more than one, and what algorithm to use to combine the task features (such as an average as shown in Equation 1).

In a step 415, target task information is determined. Using the target task, the specific geometries, orientations, positions relative to another object, and other physical geometric data can be determined for one or more of the objects used by the target task. In some aspects, the target task information can include at least one dynamic parameter. In some aspects, the target task information can include an expert action parameter. In some aspects, the target task information can include disassembly trajectory information.

In a step 420, the target task information is used by a process accessing a skill library to retrieve the most relevant skill policy that matches the target task information. The process of selecting the relevant skill policy uses a prediction process. The prediction process can utilize a task feature learning and transfer success prediction, wherein the task feature learning compares the target task information to potential source tasks in the skill library, where the comparison computes a difference in features using a point cloud. In some aspects, the relevant skill policy can be retrieved using a combination of object geometries, object dynamics, and expert actions on the object to represent a previous task in the skill library, and the combination can be compared to the target task information.

In some aspects, the retrieving can utilize task feature learning and transfer success prediction, where the task feature learning includes capturing geometry features from point cloud reconstruction, capturing dynamics features from next state prediction, and capturing expert action features from inverse dynamics prediction, and where a transfer success prediction can be performed using a neural network trained to predict the success of applying a potential skill policy to the target task using input features from a source task and the target task, including encoded geometry, dynamics, or expert actions, and the potential skill policy with the highest predicted transfer success is selected as the relevant skill policy.

In some aspects, the source task information of a skill policy can include disassembly trajectory information. In some aspects, the disassembly trajectory information can be stored as expert actions for the skill policy. Disassembly trajectory information can be used as part of the prediction algorithm to improve the match with the target task information. In some aspects, aₜ least one skill policy in the skill library includes disassembly trajectory information, enabling representation learning of dynamics and expert actions.

In some aspects, the predicted success can be determined by applying a source policy to the target task through a function to determine a scalar score measuring how well the source policy can be adapted to the target task. In some aspects, the predicted success can be determined using a transfer success predictor trained with labels obtained from applying source policies to target tasks, and where the transfer success predictor outputs a scalar score representing how well a source policy applies to the target task. In some aspects, disassembly trajectory information can be stored with disassembly actions, representing expert actions for task feature learning.

In some aspects, the transfer success prediction can be determined by comparing an average prediction of each skill policy in the skill library, where the average prediction is computed using an encoding of the source geometry of the skill policy, an encoding of a target geometry of the target task, an encoding of source dynamics of the skill policy, an encoding of target dynamics of the target task, an encoding of source expert actions of the skill policy, and an encoding of target expert actions of the target task. In some aspects, the transfer success prediction can be determined by a high zero-shot transfer success, which is determined using a prediction function, where the success is measured using the zero-shot threshold parameter, such as exceeding 90.0%.

In a step 425, the relevant skill policy is modified to fit the target task. This can occur when the target task uses different objects than the skill policy and so some robotic movements (e.g., trajectories) from the source skill policy, can be modified to fit the target task. If an error occurs, or if the relevant skill policy fails a threshold, the process can return to step 420 to re-evaluate the skill policies in the skill library. In some aspects, when this occurs, one or more of the target task information parameters can be modified. In some aspects, modifying the relevant skill policy can use a self-imitation learning process.

In a step 430, a satisfactory relevant skill policy is further fine-tuned to improve the target task success rate when implemented by a robot. In some aspects, when the high zero-shot transfer success exceeds a zero-shot threshold, the modification further includes fine-tuning the relevant skill policy. In some aspects, the fine-tuning can utilize a proximal policy optimization.

In a step 435, the modified relevant skill policy is communicated. In some aspects, the modified relevant skill policy can be stored in a data store, such as memory, a data center, a database, a hard disk, a USB key, or various other computing storage systems. The modified relevant skill policy can be used as an input to other systems, such as a robotic system or a machine learning system. In some aspects, the modified relevant skill policy can be communicated to a robotic planner system or a robotic controller (e.g., a robotic controller system). In some aspects, the modified relevant skill policy can be used by one or more operations to direct one or more robots by using the modified relevant skill policy to perform the target task. In some aspects, the modified relevant skill policy can be applied to a set of previously unseen target tasks with unknown object geometries, where the modified relevant skill policy enables zero-shot assembly in real-world environments.

Method 400 ends at a step 495. Method 400 or one or more operations of method 400 can be performed within a simulated (e.g., virtual) environment, and the modified relevant skill policy can be stored in the skill library as a previous task. This is a way to build up the knowledge within the skill library for use at a subsequent time. The skill library can be enhanced with simulated target tasks or with real-world target tasks, for example, by having the skill library be generated using previous tasks at a previous time interval.

FIG. 5 is an illustration of a block diagram of an example SRSA system 500. SRSA system 500 can be implemented in one or more computing systems or one or more processors. In some aspects, SRSA system 500 can be implemented using an SRSA controller such as the SRSA controller 600 of FIG. 6. SRSA system 500 can implement one or more aspects of this disclosure, such as method 400 of FIG. 4.

SRSA system 500, or a portion thereof, can be implemented as an application, a code library, a dynamic link library, a function, a module, a header file, other software implementations, or combinations thereof. In some aspects, SRSA system 500 can be implemented in hardware, such as a ROM, a graphics processing unit, or other hardware implementations. In some aspects, SRSA system 500 can be implemented partially as a software application and partially as a hardware implementation. SRSA system 500 is a functional view of the disclosed processes, and an implementation can combine or separate the functions in one or more software or hardware systems.

SRSA system 500 includes a data transceiver 510, an SRSA processor 520, and a result transceiver 530. The output, e.g., the relevant skill policy, can be communicated to a data receiver, such as one or more of a processing system 560 (one or more combinations of processors, processing cores, machine learning systems, one or more machine assembly systems, one or more robotic assembly systems, or one or more robotic controllers or robotic controller systems), one or more robotic planners or robotic controllers 562 (e.g., robotic controller systems), or one or more storage devices 564. The output can be used to store the relevant skill policy for use by machine assembly systems (e.g., robotic assembly systems).

In some aspects, the results of SRSA processor 520, such as those communicated to one or more processing systems 560, one or more storage devices 564, or one or more robotic planners or robotic controllers 562, can be used as input into another process or system, such as a machine learning system. The relevant skill policy can be used for further processing, such as for input into other robotic teaching, for validation of other system processes, or real-world applications, such as industrial or domestic uses.

Data transceiver 510 can receive the input parameters. The input parameters can be a target task and other operational parameters (for example, one or more threshold parameters). In some aspects, data transceiver 510 can be part of SRSA processor 520.

Result transceiver 530 (e.g., a transmitter) can communicate one or more outputs, to one or more data receivers, such as processing systems 560, one or more robotic planners or robotic controllers 562, storage devices 564, or other related systems, whether proximate result transceiver 530 or distant from result transceiver 530. Data transceiver 510, SRSA processor 520, and result transceiver 530 can be, or can include, conventional interfaces configured for transmitting and receiving data. Data transceiver 510, SRSA processor 520, or result transceiver 530 can be implemented as software components, for example, a virtual processor environment, as hardware, for example, circuits of an integrated circuit, or combinations of software and hardware components and functionality. The functionality described for these components remains intact regardless of how the functionality is implemented.

SRSA processor 520 (e.g., one or more processors such as processor 630 of FIG. 6) can implement the analysis and algorithms as described herein, utilizing the input parameters. SRSA processor 520 can be one or more of a multicore processor, a multiprocessor system, or a streaming multiprocessor. SRSA processor 520 can be implemented by a central processor unit (CPU), a graphics processor unit (GPU), or other types of processors. SRSA processor 520 can be a non-transitory computer program product having a series of operating instructions stored on a non-transitory computer-readable medium that directs a machine assembly system (e.g., robotic assembly system), when executed thereby to perform operations as disclosed herein.

A memory or data storage system of SRSA processor 520 (such as a core cache, L1 cache, L2 cache, or other memory systems) can be configured to store the processes and algorithms for directing the operation of SRSA processor 520. SRSA processor 520 can include a processor that can be configured to operate according to the analysis operations and algorithms disclosed herein, and an interface to communicate (transmit and receive) data.

FIG. 6 is an illustration of a block diagram of an example of an SRSA controller 600 according to the principles of the disclosure. SRSA controller 600 can be stored on one computer or multiple computers. The various components of SRSA controller 600 can communicate via wireless or wired conventional connections. A portion or a whole of SRSA controller 600 can be located at one or more locations. In some aspects, SRSA controller 600 can be part of another system (e.g., a processor, core, server, or other systems) and can be integrated with one device, such as a part of a processing system. SRSA controller 600 represents a demonstration of the functionality employed for the disclosure, and implementations can use a variety of devices, for example, circuits of a processor, dedicated processors, virtual systems, servers, other computing or processing systems, in software or hardware, or various combinations thereof.

SRSA controller 600 can be configured to perform the various functions disclosed herein, including receiving target tasks and generating results from the execution of the methods and processes described herein, such as relevant skill policies for use by a robotic assembly or disassembly system. SRSA controller 600 includes a communications interface 610, a memory 620, and a processor 630.

Communications interface 610 can be configured to transmit and receive data. For example, communications interface 610 can receive the input parameters. Communications interface 610 can transmit the output or interim outputs. In some aspects, communications interface 610 can transmit a status, such as a success or failure indicator of SRSA controller 600 regarding receiving the various inputs, transmitting the generated outputs, or producing the results.

In some aspects, processor 630 can perform the operations as described by SRSA processor 520. Communications interface 610 can communicate via communication systems used in the industry. For example, wireless or wired protocols can be used. Communication interface 610 can perform the operations as described for data transceiver 510 and result transceiver 530 of FIG. 5.

Memory 620 can be configured to store a series of operating instructions that direct the operation of processor 630 when initiated, including supporting code representing the algorithm for determining relevant skill policies for a robotic system. Memory 620 can be a non-transitory computer-readable medium. Multiple types of memory can be used for the data storage systems and memory 620 can be distributed.

Processor 630 can be one or more processors. Processor 630 can be a combination of processor types, such as a CPU, a GPU, a single instruction multiple data (SIMD) processor, or other processor types. Processor 630 can be configured to produce the output, one or more interim outputs, and statuses utilizing the received inputs. Processor 630 can determine the output using parallel processing. Processor 630 can be an integrated circuit. In some aspects, processor 630, communications interface 610, memory 620, or various combinations thereof, can be an integrated circuit. Processor 630 can be configured to direct the operation of SRSA controller 600. Processor 630 includes the logic to communicate with communications interface 610 and memory 620, and perform the functions described herein. Processor 630 can be capable of performing or directing the operations as described by SRSA processor 520 of FIG. 5.

For example, in some aspects, SRSA system 500 or SRSA controller 600 can perform training on target tasks with two or more objects. In some aspects, SRSA system 500 or SRSA controller 600 can be part of another system that receives the input parameters. For example, in some aspects, SRSA system 500 or SRSA controller 600 can be part of a machine learning system, an AI generative tool, or can be in a data center, a cloud system, an edge system, a corporate system, or other types of systems or locations. In some aspects, the target tasks can be received from a data store, such as when a simulation is being performed. In some aspects, SRSA system 500 or SRSA controller 600 can be part of a machine learning system, where SRSA processor 520 can be part of the machine learning processes. In some aspects, SRSA system 500 or SRSA controller 600 can implement a non-transitory computer program product having a series of operating instructions stored on a non-transitory computer-readable medium that directs a data processing apparatus, when executed thereby, to perform operations, the operations comprising the steps described herein for this disclosure, such as method 400 of FIG. 4. In some aspects, SRSA system 500 or SRSA controller 600 can implement a non-transitory computer-readable medium having a series of operating instructions that directs a data processing apparatus, when executed thereby, to perform the operations.

A portion of the above-described apparatus, systems, or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

The digital data processors or computers can be comprised of one or more GPUs, one or more CPUs, one or more other processor types, or a combination thereof. The digital data processors and computers can be proximate to each other, proximate to an intelligent machine such as an AV, in a cloud environment, a data center, or a combination thereof. For example, some components can be located proximate to the intelligent machine, such as a trained neural motion planner, and some components can be located in a cloud environment or data center, such as a neural motion planner that is being trained.

The GPUs can be embodied on a single semiconductor substrate, included in a system with one or more other devices such as additional GPUs, memory, and a CPU. The GPUs may be included on a graphics card that provides for one or more memory devices and is configured to interface with a motherboard of a computer. The GPUs may be integrated GPUs (iGPUs) that are co-located with a CPU on a single chip.

The processors or computers can be part of GPU racks located in a data center. The GPU racks can be high-density (HD) GPU racks that include high-performance GPU compute nodes and storage nodes. The high-performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that benefit from a massive compute-intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as noted above are capable of delivering the performance for training NNs for artificial intelligence and machine learning applications.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Configured or configured to as used herein means designed, constructed, or programmed to perform one or more of the noted features or functions. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

It is noted that as used herein and in the appended claims, the singular forms “a”, “an”, and “the” include plural referents unless the context clearly dictates otherwise.

Various aspects of the disclosure can be claimed, including the systems and methods. Each of the independent claims provided below may have one or more of the elements of the dependent claims presented below in combination.

Those skilled in the art to which this application relates will appreciate that other and further additions, deletions, substitutions, and modifications may be made to the described embodiments.

What is claimed is:

1. A tool for skill retrieval and skill adaptation (SRSA), comprising:
an interface configured to receive data, wherein the data includes target task information associated with a target task; and
one or more processors to perform one or more operations that include:
retrieving, using the target task information, a relevant skill policy from a skill library to perform the target task, wherein the retrieving is based on a predicted success of the relevant skill policy and the relevant skill policy includes a source geometry of at least one source object and at least one task trajectory of the at least one source object, where the at least one source object is matched to a target object of the target task, and
modifying the relevant skill policy for the target task using the target task information.

2. The tool as recited in claim 1, wherein the target task is an assembly task.

3. The tool as recited in claim 1, wherein the retrieving utilizes a task feature learning and a transfer success prediction, wherein the task feature learning comprises:
extracting target geometry features from point cloud reconstruction of the target object involved in the target task;
extracting dynamics features by predicting a next state of the target object given a current state and an action of the target object; and
extracting expert action features by predicting the action from an observed state transition using inverse dynamics prediction.

4. The tool as recited in claim 3, where the transfer success prediction is performed using a neural network trained to predict a transferability between a source task of the source object and the target task, wherein the neural network receives as input a combination of source task features and target task features, and outputs a predicted transfer success score representing how well the relevant skill policy applies to the target task, and where the source task features include of the at least one source object encoding of the source geometry, encoding of task dynamics, and encoding of expert actions, and the target task features include of the target object encoding of the target geometry, encoding of task dynamics, and encoding of expert actions.

5. The tool as recited in claim 3, wherein retrieving the relevant skill policy includes computing the transfer success prediction between each source policy in the skill library and the target task, and selecting the source policy with a highest predicted transfer success score as the relevant skill policy for the target task.

6. The tool as recited in claim 5, wherein the retrieved relevant skill policy further utilizes fine-tuning for the target task.

7. The tool as recited in claim 6, wherein the fine-tuning utilizes a proximal policy optimization.

8. The tool as recited in claim 1, wherein the predicted success is determined using a transfer success predictor trained with labels obtained from applying source policies to the target task, and wherein the transfer success predictor outputs a scalar score representing how well a source policy applies to the target task.

9. The tool as recited in claim 1, wherein the skill library is generated using previous tasks at a previous time interval.

10. The tool as recited in claim 1, wherein the relevant skill policy is retrieved using a combination of object geometries of the at least one source object, object dynamics of the at least one source object, and expert actions on the at least one source object to represent a previous task in the skill library, and the combination is compared to the target task information.

11. The tool as recited in claim 1, wherein the modifying the relevant skill policy uses a self-imitation learning process.

12. The tool as recited in claim 1, wherein the one or more operations are performed within a simulated environment and the modified relevant skill policy is stored in the skill library as a previous task.

13. The tool as recited in claim 1, wherein the one or more operations further include directing one or more robots using the modified relevant skill policy to perform the target task.

14. The tool as recited in claim 1, wherein at least one skill policy in the skill library includes disassembly trajectory information enabling representation learning of dynamics and expert actions.

15. The tool as recited in claim 14, wherein the disassembly trajectory information is stored with disassembly actions, representing expert actions for task feature learning.

16. A robotic assembly system, comprising:
a skill library configured to store skill policies, wherein each of the skill policies include source task information that includes a source task, a source geometry of at least one source object of the source task, at least one dynamic of the at least one source object, and at least one expert action of the at least one source object; and
one or more processors configured to receive a target task and target task information of the target task, retrieve a relevant skill policy from the skill policies to perform the target task utilizing a predicted success of the relevant skill policy to perform the target task with the target task information, and modify the relevant skill policy for the target task using the target task information, wherein the target task information includes a target geometry of at least one target object of the target task and at least one dynamic of the at least one target object.

17. The robotic assembly system as recited in claim 16, further comprising:
a robot configured to perform the target task using at least the target object and the modified relevant skill policy.

18. The robotic assembly system as recited in claim 16, wherein the target task is an assembly task of two objects, one of which is the target object.

19. The robotic assembly system as recited in claim 16, further comprising:
a machine learning system configured to work with the one or more processors to analyze the target task information and to select the relevant skill policy using a machine learning process of the machine learning system.

20. The robotic assembly system as recited in claim 16, wherein the one or more processors are part of or executing on a central processor unit (CPU) or a graphics processor unit (GPU).

21. The robotic assembly system as recited in claim 16, wherein the modified relevant skill policy is used by a robotic planner or a robotic controller system to direct the movement of a robotic assembler.

22. The robotic assembly system as recited in claim 16, wherein the relevant skill policy includes the source geometry of at least one source object.

23. The robotic assembly system as recited in claim 16, wherein the relevant skill policy includes at least one task trajectory of the at least one source object.

24. A method of operating a robot for a new assembly task, comprising:
receiving a target task, wherein the target task is an assembly task of at least two objects;
determining target task information associated with the target task;
retrieving, using the target task information, a relevant skill policy from a skill library to perform the target task, wherein the retrieving is based on a predicted success of the relevant skill policy; and
modifying the relevant skill policy for the target task.

25. The method as recited in claim 24, further comprising:
directing operations of a robotic assembly system using the modified relevant skill policy.

26. The method as recited in claim 24, further comprising:
applying the modified relevant skill policy to a set of previously unseen target tasks with unknown object geometries, wherein the modified relevant skill policy enables zero-shot assembly in real-world environments.

27. The method as recited in claim 24, further comprising:
using the modified relevant skill policy by a robotic planner or a robotic controller system.

28. The method as recited in claim 24, further comprising:
using the modified relevant skill policy as an input for a machine learning process or a robotic learning process.

29. The method as recited in claim 24, further comprising:
simulating a robotic assembly system, the target task, and the skill library within a machine learning system.

30. A non-transitory computer program product having a series of operating instructions stored on a non-transitory computer-readable medium that directs a robotic assembly system when executed thereby to perform operations, the operations comprising:
receiving a target task, wherein the target task is an assembly task of aₜ least two objects;
determining target task information associated with the target task;
retrieving, using the target task information, a relevant skill policy from a skill library to perform the target task, wherein the retrieving is based on a predicted success of the relevant skill policy; and
modifying the relevant skill policy for the target task.

31. The non-transitory computer program product recited in claim 30, wherein the retrieving further comprises:
utilizing task feature learning and transfer success prediction to select the target task.

32. The non-transitory computer program product recited in claim 31, wherein the task feature learning includes capturing geometry features from point cloud reconstruction, capturing dynamics features from next state prediction, and capturing expert action features from inverse dynamics prediction.

33. The non-transitory computer program product recited in claim 31, wherein the transfer success prediction is performed using a neural network trained to predict a success of applying a potential skill policy to the target task using input features from a source task and the target task, including at least one of encoded geometry, dynamics, or expert actions, and the potential skill policy with a highest predicted transfer success is selected as the relevant skill policy.
